(19) United States
(12) Patent Application Publication
(10) Pub. No.: US 2007/0017144 A1
(43) Pub. Date: Jan. 25, 2007

(54) Fishing Line Reel Stringer

(76) Inventor: Roberto Colon, Toledo, OH (US)

Correspondence Address: Benjamin Arthur Randall, 448 W. Woodruff, Toledo, OH, 43624, US

(21) Appl. No.: 11/161,157

(22) Filed: Jul. 25, 2005

(51) Int. Cl. A01K 97/00

(52) U.S. Cl. 43/25

(57) ABSTRACT

A device for holding and dispensing fishing line under variable pressure. The device attaches to a fishing pole and holds the line spool as line is wound onto the fishing reel. The device allows fishing line spools with varying size center holes to be accommodated. A hollow cone used in conjunction with the device that is rotated using an electric drill for rewinding line from the fishing pole to the line spool.

The present invention relates to fishing rods and reels. Specifically the invention is a device that holds a spool of fishing line so new line may be placed on the reel of the fishing pole. The invention is attached to the fishing pole and holds the fishing line spool in a manner facilitating the release of the line from the spool and onto the fishing pole reel. The invention has a size variable clamping mechanism to enable it to attach to any size pole. The invention also has a variable sized spindle for holding spools with differently sized center holes. The invention also has means for providing a variable tension on the spool so the line is wound onto the reel of the fishing pole without any slack.

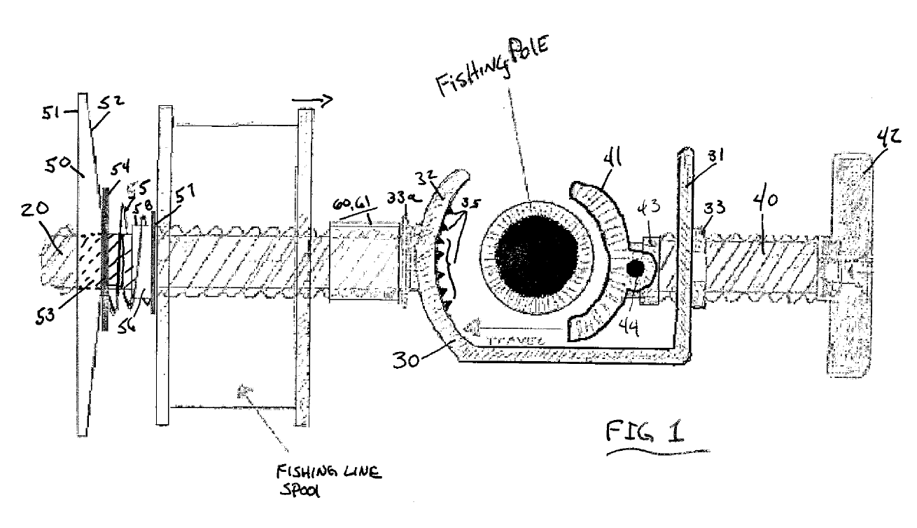

With reference to FIG. 1, the spool holder is seen generally at 10. The spool holder 10 comprises a spindle 20, a body 30, and a clamping screw 40. The body 30 is a three-sided solid in a “C” or “U” shape much like a C-clamp. In a preferred embodiment of the invention the body 30 is shaped like a “U” with an elongated bottom edge and two upward pointed legs, a screw leg 31, and a spindle leg 32. The screw leg 31 will generally be straight, while the spindle leg 32 will generally curve inward to assist in capturing a fishing pole. A fishing pole will naturally be driven to the deepest part of the curve, and thereby be restrained from moving to either side by the curve. This provides a significant advantage over designs that utilize a flat or non-curved surface. On the curved portion of the spindle leg 20, on an inside face, can be seen a plurality of ridges 35 that protrude outward from the inside face. The ridges extend the width of the body 30 and are generally triangular in cross section. It is anticipated that other cross sections such as cylindrical could be used. The ridges 35 assist in holding a fishing pole in place during use of the invention. The body 30 will also be of a depth sufficient to create structural strength. The overall dimensions of the invention are a mixture of aesthetic and engineering requirements and are not critical to the inventive qualities of the invention. In a preferred embodiment, the invention is small enough to fit in a tackle box, but large enough to be structurally sound.

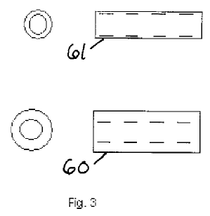

The body 30 and the legs, 31 and 32, create an open throat section between the two legs 31 and 32 which is designed to be large enough to accommodate any fishing pole, including the larger deep sea fishing poles. It is anticipated that the invention could be practiced by making it different sizes to accommodate larger or smaller fishing poles. The screw leg 31 comprises a reinforced section 33 located near an upper end of screw the leg 31. The reinforced section in the preferred embodiment is a portion of the leg that is thicker than the body 30. In those embodiments of the invention that use a thicker body, a reinforced section will not be needed. Using a thinner body reduces the weight of the invention. A thinner body has the disadvantage of increased flexing when pressure is applied to the fishing pole with the clamping screw 40. Referring to FIG. 4, an embodiment can be seen wherein the body 30 comprises a relatively thin, flat reinforcing rib 34 outwardly extending from the body 30, to counteract the flexing. The rib 34 will be generally located in the middle of the body, 30.

Referring again to FIG. 1, the reinforced section 33 is of sufficient size to accommodate the screw 40 and supplies sufficient thread engagement to prevent the screw 40 from slipping due to the force generated by the screw 40 when it is tightened on a fishing pole. The size of the reinforced area 33 and the size of the screw 40 are parameters that can be varied depending upon the desired look and feel of the invention and are not critical to the inventive quality of the invention. The selection of the type of screws and the engagement thereof are matters well known in the art. In a preferred embodiment, the screw 40 is a ¼-20 threaded rod. It is anticipated that the screw 40 may be constructed of a metal threaded rod, or a plastic threaded rod. Use of a plastic rod will generally require the screw 40 to be of a larger diameter. It is anticipated that the present invention may be practiced so that the invention will be constructed of materials sufficiently less dense than water so that the invention would float if accidentally dropped in the water.

Again referring to FIG. 1, the screw 40 comprises an inner end having a pad 41, and an outer end having a handle 42. The pad 41 fits against the fishing pole when the invention 10 is clamped onto a pole. In the embodiment shown in FIG. 1, the pad 41 has a curved inner surface to accommodate the curvature of a fishing pole, which are generally cylindrical. It is anticipated that a suitable curvature may not be found for all diameter fishing poles. Referring to FIG. 4, the invention can be seen wherein the pad 41 is flat on the inner surface. A flat inner surface on the pad 40 would be useful for larger diameter poles. It is also anticipated that the invention may be practiced with removable pads that may be changed from flat to curved to accommodate larger and smaller poles.

Referring again to FIG. 1, the handle 42 is used to tighten and loosen the screw 41 to hold the invention 10 in place. In a preferred embodiment, the pad 41 is made from a soft material such as rubber, plastic, or cork so as not to damage the fishing pole when the invention 10 is clamped to it. The pad 41 may be attached to the screw 40 using a ball and socket mechanism 43 so the pad 41 does not rotate when brought into contact with the fishing pole. This method of construction is well known in the art. The pad 42 may also be hinged using a pin 44 so that the pad 42 can adjust itself to the fishing pole during use. The handle 42 may be attached to the screw 40 by any conventional means such as a spline, using a screw and washer or gluing. Such means are well known in the art.

Referring again to FIG. 1, the spindle leg 32 also comprises a reinforced section 33a. The reinforced section 33a is sized to accommodate a threaded rod, the spindle 20. The spindle 20 is attached to the reinforced section 33a by providing a threaded hole to thread it into, and/or gluing it with a suitable glue. Such methods are well known in the art. In the preferred embodiment the spindle 20 is a length of ¼ 20 threaded rod, although other types of rod could be used including other types of threaded rod, or rod that is partially threaded along it's length. The inventive property of the spindle 20 is to provide a means of securing the line spool to the invention with providing a means of tensioning the line as it is released in conjunction with other elements of the invention. The spindle 20 is long enough to accommodate standard fishing spools and a tensioning means. The spindle 20 is short enough so that it will easily fit in most tackle boxes. In a preferred embodiment of the invention the body 30, the legs 31 and 32, and the reinforced sections 33 and 33a are a single unit formed by injection molding or some other suitable process. It is envisioned that the invention comprises materials that corrosion resistant such as aluminum or stainless steel or plastics.

Referring to FIG. 1, the tensioning means can be seen. The tensioning means comprise an adjustment wheel 50, a flat washer 54, a helical spring 55, and a bushing 56. The adjusting wheel 50 comprises a shortened cylindrical body of sufficient diameter to easily rotate, having a flat face 51, and a rounded face 52. The adjusting wheel 50 further comprises a center threaded hole 53 which accommodates and mates to the threads on the spindle 20. The adjusting wheel 50 is separated from the fishing line spool by use of a flat washer 54, a helical spring 55, and a bushing 56. The bushing 56 has a flat face 57 extending from and perpendicular to it's body, and an elongated cylindrical body 58 of lesser diameter than the flat face extending away from the flat face 57 toward the adjusting wheel 50. The body 58 extends into the small end of the helical spring 55 as shown. In practice, a spool of fishing line will be placed on the spindle 20. The bushing 56, helical spring 55, and flat washer are then placed on the spindle 20 as shown in FIG. 1. The adjusting wheel 50 is then threaded onto the spindle 20, with the rounded face 52 facing inward. The adjusting wheel 50 is tightened against the flat washer 54, compressing the spring 55 thereby putting pressure on the bushing 56. The pressure forces the flat face 57 against the fishing line spool. The pressure can be increased by running the adjusting wheel inward, or lessened by backing it off. In this manner, the force necessary to remove line from the spool can be varied. In this manner it can be assured that the new fishing line is wound onto the reel of the fishing pole with sufficient tension so that it is wound evenly and without slack. The rounded face 52 ensures that there is little friction between the adjusting wheel and the flat washer 54 so the adjusting wheel 50 does not turn as the spool turns. In a preferred embodiment of the invention, the flat washer 54 is plated or polished to provide a smooth surface. The rotation of the fishing line spool will impart rotation to the bushing 56. The bushing 56 is in contact with the helical spring 55 only at the top of the spring 56, thereby minimizing the rotational force transmitted to the spring 56. The body 58 of the bushing 56 is preferred to be smaller than the diameter of the small end of the spring 55 so that no rotational force is transmitted to the spring 55 by the body 58. The flat washer 54, the helical spring 55 and the bushing 56 all have a central cylindrical hole of a slightly larger diameter than the spindle 20 so that they may easily fit onto the spindle 20. In the preferred embodiment of the invention the adjusting wheel 50 is a solid disk, but it is envisioned that the adjusting wheel be provided with a plurality of through holes, scalloped edges, or other decorative features.

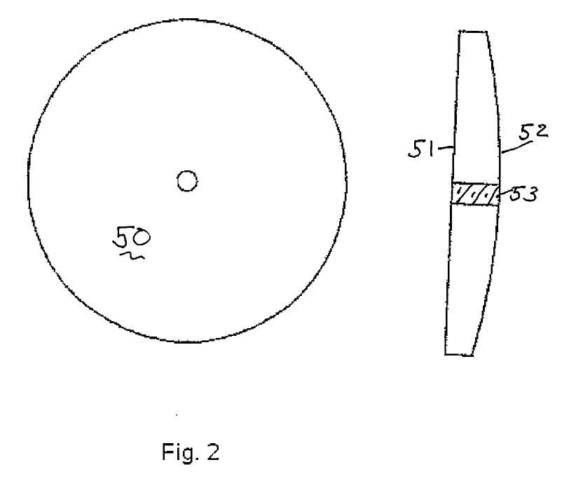

Referring to FIG. 3, the adjustment dowels 60 and 61 may be seen. It is standard in the manufacture of fishing line to provide fishing line on spools that have a center hole in the spool. It is also standard that light gauge fishing line be provided on a spool that has a small diameter hole, and to provide heavy gauge fishing line, such as that used in deep sea fishing, on a larger spool with a larger center hole. The present invention is designed to allow use on all types of fishing rods, and all types of line spools. The adjustment dowels 60 and 61 make the spool holder 10 suitable for use with both types of standard line spools. The adjustment dowels 60 and 61 are hollow elongated cylinders. The inside diameter of the adjustment dowels 60 and 61 is sized so that it may easily fit over the spindle 20, yet be tight enough so that the fishing line spool does not wobble when placed over the dowels, 60 or 61. In the preferred embodiment, the inside diameter of the adjustment dowels 60 and 61 are slightly larger than the outside diameter of the threaded rod being used. The outside diameter of the adjustment dowels 60 and 61 are slightly smaller than the inside diameter of the center hole in the fishing line spools provided by the manufacturers. The dowels 60 and 61 are of sufficient length to support a spool, yet are short enough so that they do not extend beyond the spool when in use. This allows the flat face 57 of the bushing 56 to be directly against the spool rather than be against the dowel.

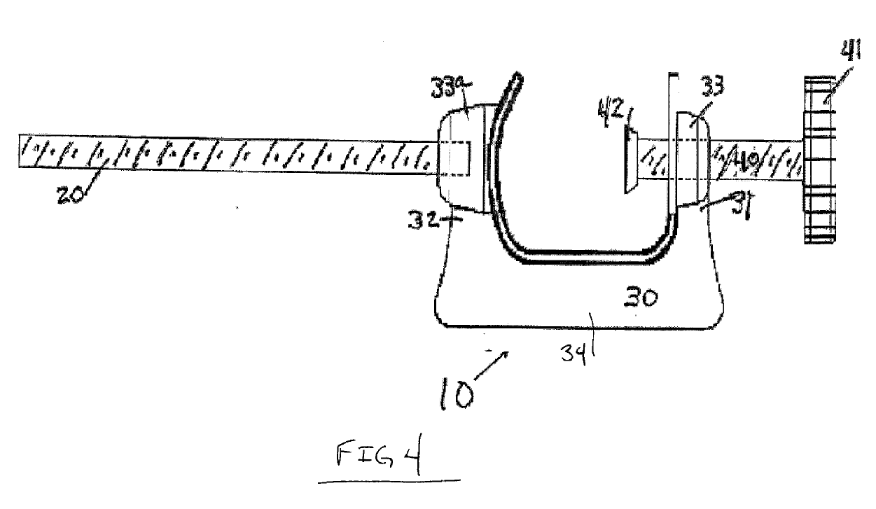

It is also anticipated that the invention may be practiced by supplying a body 30 that is decorative as well as functional. Referring to FIG. 5, the present invention can be seen wherein the body 30 has been formed to resemble a fish. The handle 42 has been shaped to resemble a fishes' tail.

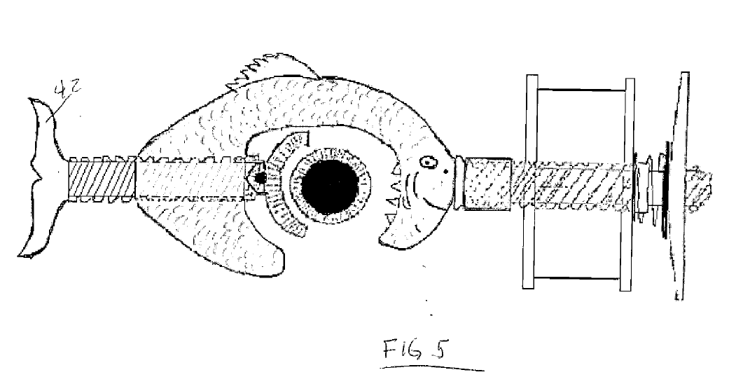

Referring to FIG. 6, a rewinding cone 80 may be seen. The cone 80 is used to rewind fishing line from the fishing pole to a reel if the fisherman wishes to use a different gauge line and the line on the fishing pole is worth saving. The spool holder 10 is placed on the fishing pole as previously described. The fishing line presently in use on the pole is secured to a reel. The rewinding cone 80 has a shaft end 81, and a friction end 82. The shaft end 81 is sized so that it may be inserted into a standard drill chuck. The drill chuck will be tightened on the shaft end so that rotation from the drill will be transmitted to the rewinding cone 80. It is anticipated that a hand-held drill will be used for this procedure. The friction end 82 of the rewinding cone 80 will be placed against the reel the line is to be rewound upon. In this procedure, the tensioning means will not be used, and the reel will set upon the spindle 20 without anything between its outer end and the rewinding cone 80. The rewinding cone 80 will be hollow so that the spindle 20 can fit up inside it. The drill will be operated in a direction so as to take up the line upon the reel.

What is claimed is:

1. A device removably attached to a fishing pole for holding the fishing pole and a spool of fishing line in proximity to each other facilitating winding of new line upon a reel of said fishing pole comprising:
a “C” shaped body having a first leg, a second leg and a center portion between said legs,
said legs being contiguous with said center portion, said legs extending outwardly from
said center portion in the same direction, said legs being generally parallel to each other, and spaced apart to form a space therebetween to accommodate a fishing pole,
means for securing a fishing pole in said space,
means for securing a reel of fishing line to said body allowing said spool to rotate along a center axis of the spool,
said first leg supporting said means for securing a fishing pole, and
said second leg supporting said means for securing said reel.

2. The device as recited in claim 1 wherein said means for securing a fishing pole is an elongated threaded member having a first inner end and a second outer end, and wherein said supporting means on said first leg is a integrally molded section of said leg having a threaded hole formed therethrough said threads corresponding to the threads on said elongated member.

3. The device as recited in claim 2 wherein said first inner end of said threaded member has a pad attached thereto.

4. The device as recited in claim 3 wherein said pad is rotatably mounted to said first inner end.

5. The device as recited in claim 2 wherein said second outer end has a handle attached thereto.

6. The device as recited in claim 1 wherein said means for securing said reel is an elongated cylindrical rod having a first end secured to said second leg and a second end, said rod having threads for at least part of it's length, said threads starting at said second end, and wherein said means for securing said reel comprise means for applying friction to said reel.

7. The device as recited in claim 6 wherein said means for applying friction to said reel comprises a disk having a centrally located threaded hole mating to said threads on said elongated cylindrical rod, said disk having a rounded inner face.

8. The device as recited in claim 7 wherein said means for applying friction further comprises a spring and washer assembly, said assembly comprising:
a flat washer disposed against said rounded inner face,
a bushing with an outwardly extending flat face, and
a helical spring disposed therebetween.

9. The device as recited in claim 8 wherein said bushing comprise a cylindrical body having a first end and a second end, said first end extending into an interior space of said spring, said second end extending beyond said spring and wherein said flat face of said bushing is contiguous with said second end and extends perpendicular to said cylindrical body of said bushing, said flat face having an outside diameter in excess of an outside diameter of said spring.

10. The device as recited in claim 1 further having means to adapt to fishing line spools with varying sized center holes.

11. The device as recited in claim 10 wherein said means to adapt are elongated cylindrical members having an opening therethrough along their elongated axis, and wherein said opening is of sufficient size to fit over said spindle.

12. The device as recited in claim 9 wherein said “C” shaped body comprises a central rib perpendicular to and extending outwardly from said body.

13. The device as recited in claim 9 wherein said “C” shaped body is in an ornamental form of a fish.

14. A device for winding fishing line from a fishing pool reel onto a spool comprising:
a “C” shaped body having a first leg, a second leg and a center portion between said legs,
said legs being contiguous with said center portion, said legs extending outwardly from said center portion in the same direction, said legs being generally parallel to each other,
and spaced apart to form a space therebetween to accommodate a fishing pole,
means for securing a fishing pole in said space,
means for securing a reel of fishing line to said body allowing said spool to rotate along a center axis of the spool,
said first leg supporting said means for securing a fishing pole,
said second leg supporting said means for securing said reel,
a hollow cone having a larger open first end and a smaller second end wherein said first end of said cone has a diameter smaller than the outside diameter of said spool, said second end having a diameter small enough to fit into a standard drill chuck, and wherein said cone is long enough to accommodate said means for securing a reel of fishing line.
